(19) United States
(12) Patent Application Publication
(10) Pub. No.: US 2018/0191820 A1
(43) Pub. Date: Jul. 5, 2018

(54) PROCESSING OF COMPLEX WORKLOADS

(71) Applicant: International Business Machines Corporation, Armonk, NY (US)

(72) Inventors: Rafael C.S. Folco, Santa Barbara d'Oeste (BR); Breno H. Leitao, Araraquara (BR)

(21) Appl. No.: 15/397,778

(22) Filed: Jan. 4, 2017

(51) Int. Cl. H04L 29/08; H04L 12/24; H04L 12/26

(52) U.S. Cl. CPC H04L 67/1025; H04L 43/08; H04L 41/12; H04L 67/148

(57) ABSTRACT

Embodiments of the present invention provide systems and methods for enhancing the processing of workloads. The method includes identifying features associated with a workload. The method further includes separating the workload into parts, determining a respective zone is suitable for the parts, and migrating the parts to the respective zone determined to be suitable.

### BACKGROUND OF THE INVENTION

The present invention relates generally to handling computer workloads, and more particularly to increasing the efficiency of complex workloads through migration to tuned zones in a cloud environment based on workload characteristics.

In a computing environment, complex workloads may be composed of multiple types of applications, including webservers, databases, low latency apps, and a myriad of other applications. These complex workloads may be passed to a cloud computing environment for processing in order to remove some of the processing load from the local machine, to increase processing performance, or for other reasons.

### SUMMARY

According to one embodiment of the present invention, a method for enhancing the processing of workloads. The method includes identifying, by one or more processors, features associated with a workload; separating, by one or more processors, the workload into a plurality of parts, based, at least in part, on the identified features; determining, by one or more processors, a respective zone of a plurality of zones is suitable for at least one part of the plurality of parts in a cloud environment; and responsive to determining the respective zone of the plurality of zones is suitable, migrating, by one or more processors, the one part to the respective zone determined to be suitable.

According to another embodiment of the present invention, a computer program product for enhancing the processing of workloads is provided, based on the method described above.

According to another embodiment of the present invention, a computer system for enhancing the processing of workloads is provided, based on the method described above.

### BRIEF DESCRIPTION OF THE DRAWINGS

FIG. 1 is a cloud computing environment, in accordance with an embodiment of the present invention;

FIG. 2 is abstraction model layers, in accordance with an embodiment of the present invention;

FIG. 3 is a functional block diagram illustrating a data processing environment, in accordance with an embodiment of the present invention;

FIG. 4 is a flowchart illustrating operational steps for profiling and migrating parts of a workload to appropriately tuned zones in a cloud environment, in accordance with an embodiment of the present invention;

FIG. 5A is a visualization depicting various featured zones in a cloud environment, in accordance with an embodiment of the present invention;

FIG. 5B is a visualization that depicts a migrating of parts of a workload to a cloud environment, in accordance with an embodiment of the present invention; and

FIG. 6 is a block diagram of internal and external components of the computing device of FIG. 3, in accordance with an embodiment of the present invention.

### DETAILED DESCRIPTION

Embodiments of the present invention recognize that processing complex workloads can be inefficient. In some instances, complex workloads may be passed to a cloud computing environment (also known as a “cloud environment” or just “the cloud”). However, the cloud may not be designed to handle, in an efficient manner, the workloads assigned to it. Even when the cloud is designed to handle certain parts (or “pieces”) of the workloads assigned, the workloads may have multiple parts, and the cloud may not be designed to handle other parts of the workload efficiently. For example, the cloud may be designed to handle webservers, but the workload assigned may not only have webservers, but also may have databases, scalable web apps, etc. The cloud may be able to handle all of these parts of the workload, but is only efficiently handling the webserver portion of the workload. This may cause a bottleneck or other slowdowns in processing the workloads assigned to the system.

Embodiments of the present invention further recognize the need to profile and separate the various workloads and transfer, or migrate, the appropriate parts of the workloads to an appropriate zone in the cloud. The cloud may be divided into zones designed to handle various types of workloads. For example, a cloud may be broken into different featured zones, where one zone is designed to handle low latency applications, another zone is designed to handle I/O intensive applications, and yet another zone is designed to handle memory intensive applications. Embodiments of the present invention provide solutions for dynamically profiling, separating, and migrating the various parts of the workload to the appropriate zones in the cloud, based on the workload characteristics (also referred to as “features”). In this manner, as discussed in greater detail herein, embodiments of the present invention can provide solutions for improving performance of workload processing through profiling and migrating the various types of applications, tasks, other resources, etc. associated with a specific workload to the zone in a cloud that is designed for that type of application.

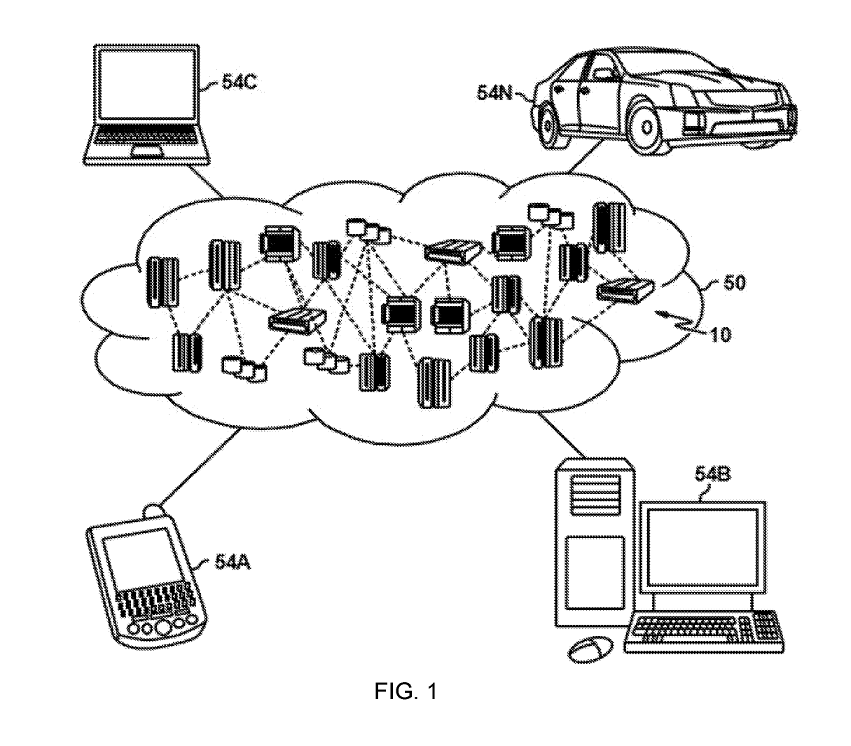

The present invention will now be described in detail with reference to the Figures. FIG. 1 is a cloud computing environment, in accordance with an embodiment of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that cloud computing nodes 10 and cloud computing environment 50 can communicate with any type of computerized device over any type of network and/or network addressable connection (e.g., using a web browser).

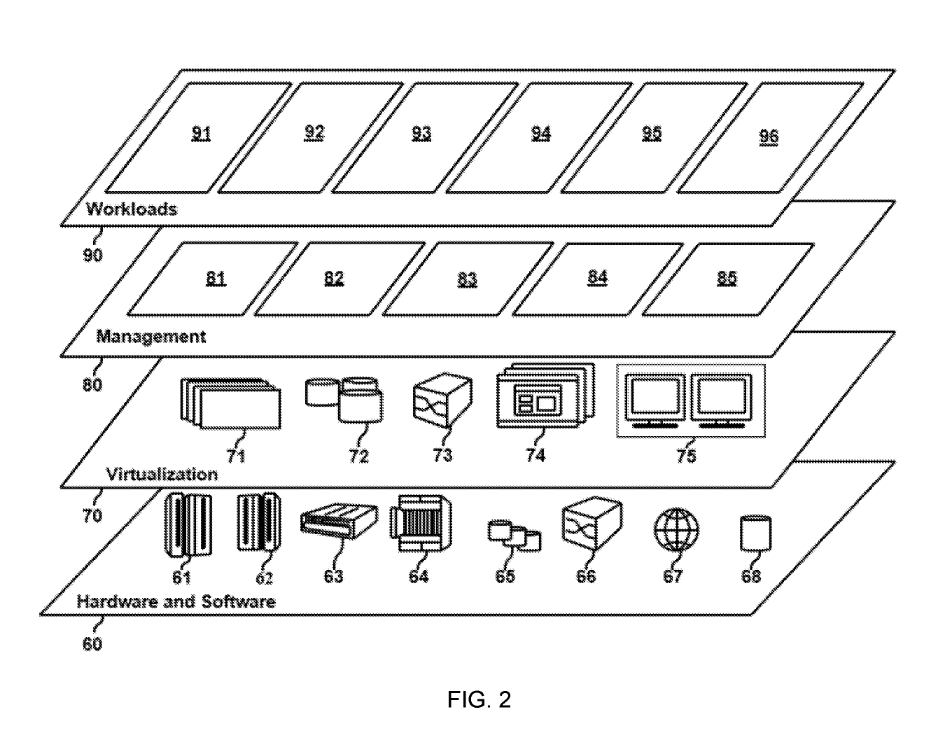

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and appropriate, tunable featured zone 96.

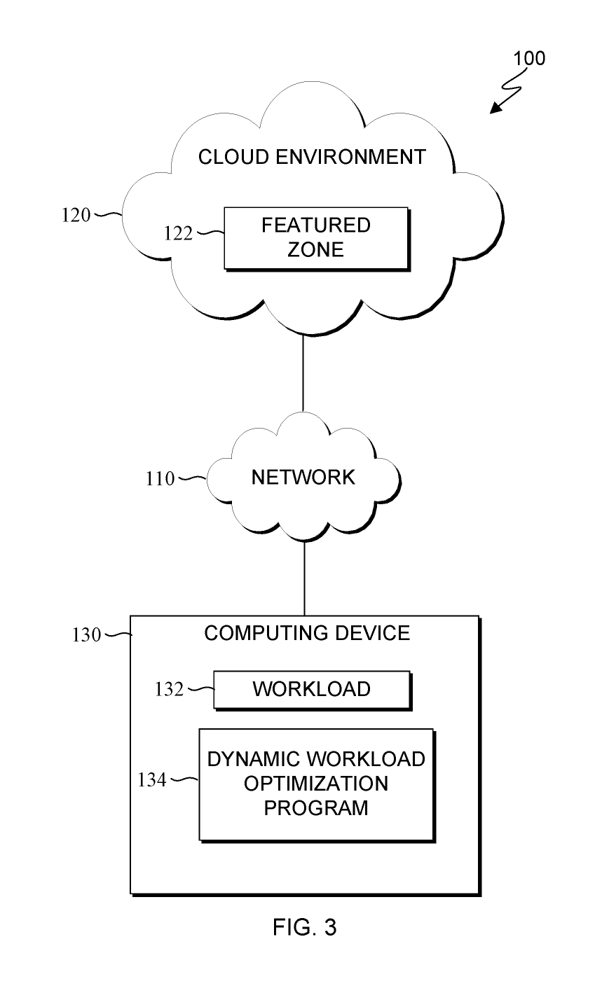

FIG. 3 is a functional block diagram illustrating a data processing environment, generally designated 100, in accordance with an embodiment of the present invention. Modifications to data processing environment 100 may be made by those skilled in the art without departing from the scope of the invention as recited by the claims. In an exemplary embodiment, data processing environment 100 includes cloud environment 120 and computing device 130, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication and/or access between cloud environment 120 and computing device 130.

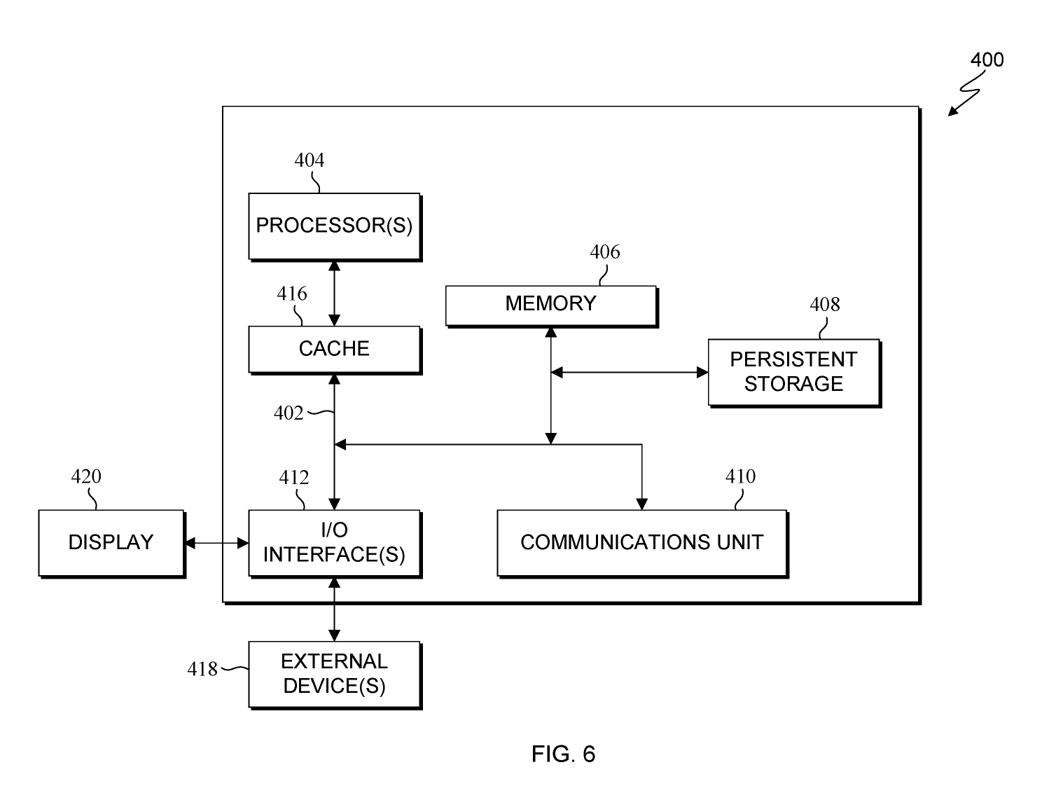

Computing device 130 includes workload 132 and dynamic workload optimization program 134. In various embodiments of the present invention, computing device 130 can be a laptop computer, a tablet computer, a netbook computer, a personal computer (PC), a desktop computer, a server computer, a personal digital assistant (PDA), a smart phone, a thin client, or any programmable electronic device capable of executing computer readable program instructions. Computing device 130 may include internal and external hardware components, as depicted and described in further detail with respect to FIG. 6.

Workload 132 is an amount of processing that the computer (e.g., computing device 130) has been given to do at a given time. Workload 132 may include workload information and resources with which to accomplish the tasks associated with workload 132. In this exemplary embodiment, workload information includes tasks to be accomplished, users associated with the tasks, resources associated with the tasks, allocation of those resources associated with the tasks, some amount of processing that the computer has been given to do, etc. Resources with which to accomplish the tasks associated with workload 132 may include one or more webservers, databases, scalable web apps, low latency apps, etc., all requiring some amount of processing power and computing resources. In this embodiment, workload 132 is running originally on computing device 130. In various additional embodiments, workload 132 may be running partly or fully on other environments, for example on additional computing devices (not shown).

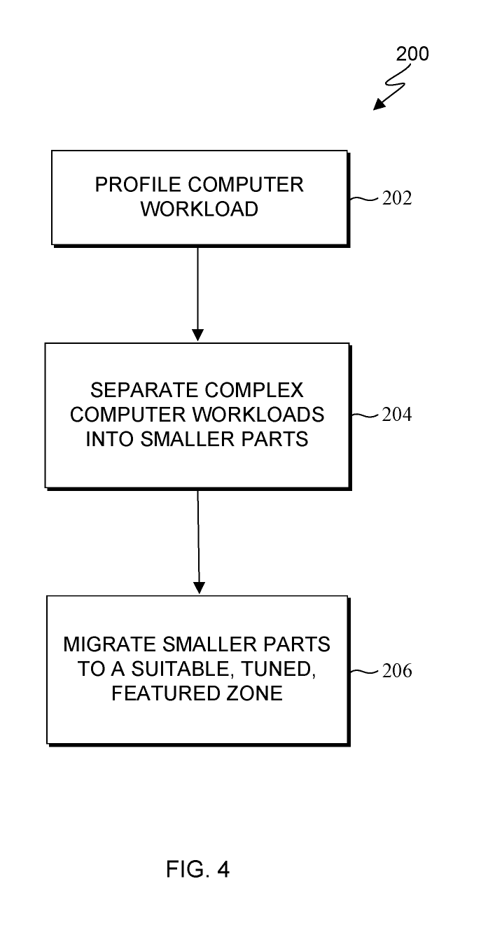

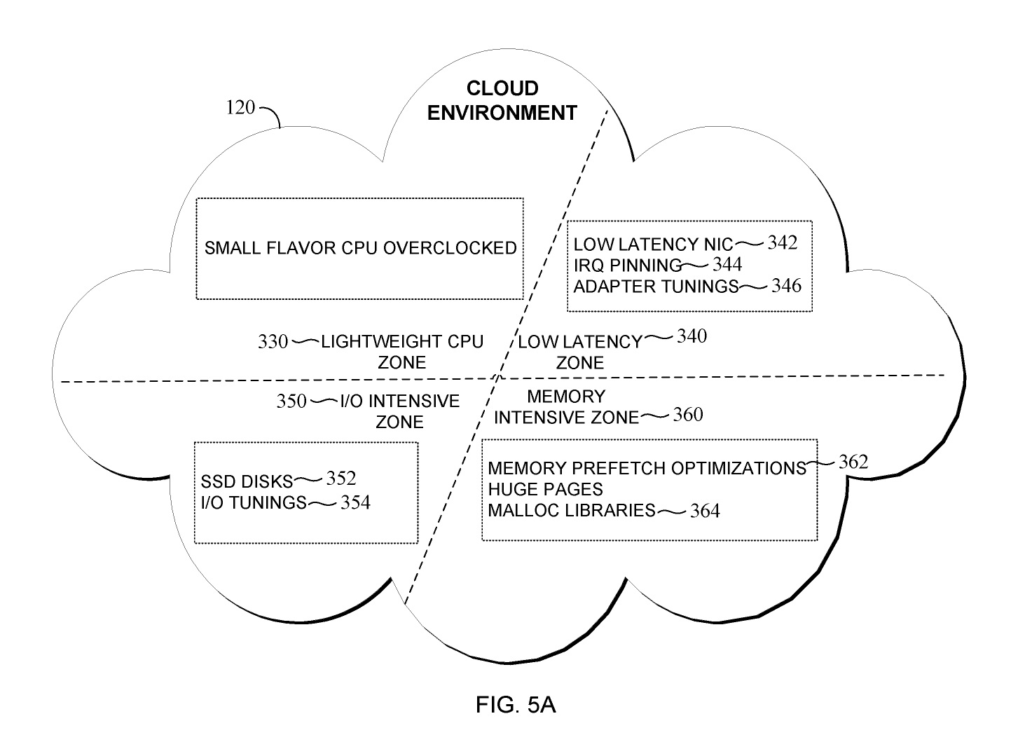

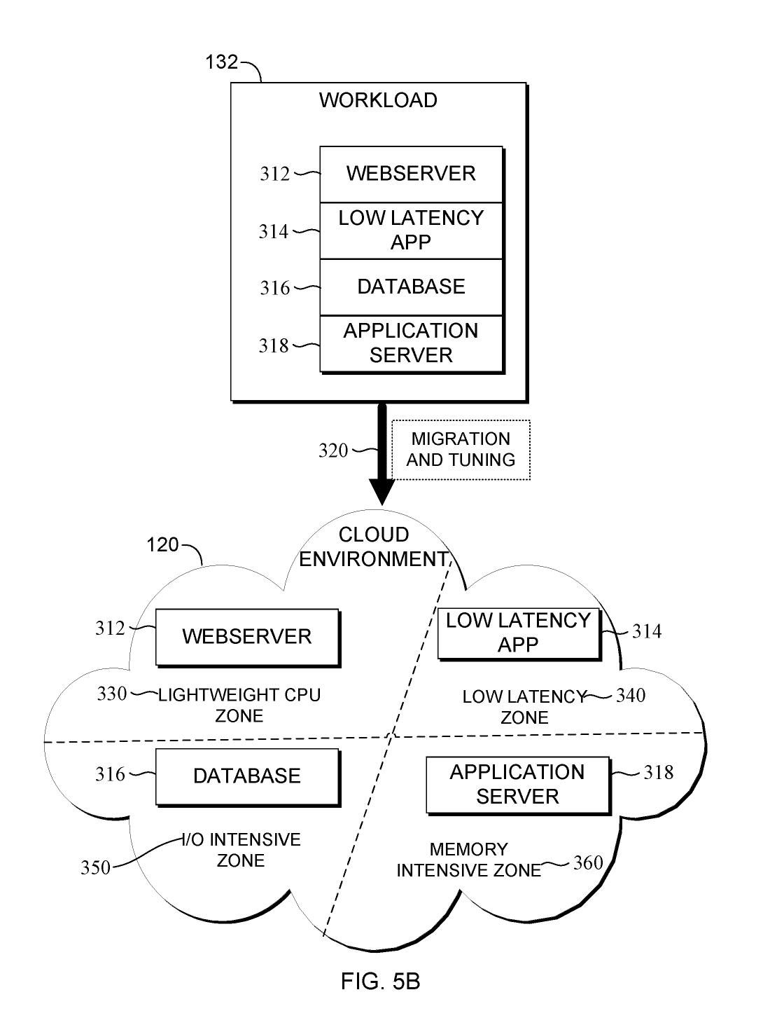

Dynamic workload optimization program 134 is program that dynamically profiles a computer workload, separates the computer workload into pieces and migrates the pieces into tuned, featured zones in a cloud environment. In this embodiment, dynamic workload optimization program 134 dynamically accesses and analyzes workload 132. As described in greater detail in FIGS. 4, 5A, and 5B, dynamic workload optimization program 134 analyzes workload 132 by profiling (also referred to as “identifying”) workload 132 and workload 132's various programs to determine the individual pieces and certain characteristics of those pieces, enhance the processing of the various programs by separating workload 132's various programs into separate, parts based on the profile, and migrate the parts to the appropriate zones in cloud environment 120, via network 110. In various embodiments, dynamic workload optimization program 134 can be separate programs, included in a single program, or on separate devices, for example on cloud environment 120 or on an additional computing device (not shown).

In additional embodiments, dynamic workload optimization program 134 can generate an interactive display (not shown), for a user, that lists the various parts of workload 132, based on the parts identified, profiled characteristics, etc. The display may include an itemized list of the components of the workload (e.g., workload 132) and include recommendations for featured zones, or recommended zone tuning, that are suitable for the parts in-line with the itemized list. In this example, the user may interact with the list to allow dynamic workload optimization program 134 to place the various parts into featured zones, or establish rules for dynamically placing parts into featured zones.

Cloud environment 120 is a cloud based computing environment, and includes featured zone 122. Featured zone 122 may include multiple different zones. In this embodiment, cloud environment 120 is a network of servers with various functions, which are accessible, generally, from anywhere with an internet connection. For example, some of the servers that make up cloud environment 120 may use computing power to run applications, while other servers may be used for storing data. Cloud environment 120 may be a small or large network of servers, and may be housed locally to computing device 130, such as in the same building, or may be housed globally, such as in a different country. In additional embodiments, the servers for cloud environment 120 are housed in multiple locations at the same time, and connected to each other over network 110.

In this embodiment, featured zone 122 is a specially tuned environment. Featured zone 122 may include multiple portions or segments. Each of these zones and/or segments may be specifically tuned for handling specific tasks. Each tuning element of featured zone 122 is designed to help that zone handle specific types of applications. In this embodiment, featured zone 122 is a segment of cloud environment 120, or a virtual machine running on cloud environment 120. Additionally, featured zone 122 may be a variety of zones all tuned to different applications and the requirements of those different applications. For example, a zone tuned for memory intensive applications may have memory prefetch optimizations and be designed to support huge pages (also called superpages, or large pages, depending on the operating system). A zone tuned for low latency, on the other hand, may have a specially designed low latency network interface controller (NIC) and an interrupt request (IRQ) pinning specifically for low latency. In various embodiments, there can be more than one featured zone 122, each featured zone 122 may include multiple segments, and each featured zone 122, or segment therein, may have completely separate tunings, or may share some common tuning elements with other featured zones of featured zone 122 or segments therein. For example, more than one featured zone 122 may have a memory prefetch tuning.

In various embodiments, the rules for the tuning of featured zone 122, and how many featured zone 122s there are, can be set up by the owner of cloud environment 120, the user of cloud environment 120, etc., and may be static, or change depending on such factors as user needs, predetermined rules, etc.

FIG. 4 is a flowchart 200 illustrating operational steps for profiling and migrating parts of a workload to appropriately tuned zones in a cloud environment, in accordance with an embodiment of the present invention.

In step 202, dynamic workload optimization program 134 profiles a computer workload, such as workload 132. In this exemplary embodiment, dynamic workload optimization program 134 profiles a computer workload by accessing workload 132 from computing device 130. Dynamic workload optimization program 134 then profiles workload 132 by examining the workload as a whole and its various pieces to determine what applications, tasks, other resources, etc. are associated with workload 132 and the various characteristics of the applications. For example, workload 132 may comprise a webserver, a low latency app, a database, and an application server. In this example, dynamic workload optimization program 134 may determine, due to various built-in characteristics, usage history, comparisons with similar programs, etc., that the database portion of workload 132 is I/O intensive, the webserver requires very lightweight CPU usage, the application server is memory intensive, and the low latency app is low latency.

In various embodiments, there can be more or less applications that make up workload 132, more than one characteristic for each application, and/or the various applications may have one or more of the same characteristics. For example, both the webserver and the application server may be profiled as memory intensive.

In various additional embodiments, the applications can fit into more than one characteristic and can be profiled to one characteristic over another based on various criteria and rules. For example, an application server may be low latency, but also very memory intensive, and predefined rules for dynamic workload optimization program 134 may state that if an application is low latency, but memory intensive, the memory intensive characteristic holds precedence. The various criteria and rules may be established by the owner of the cloud, the users of the applications, dynamic workload optimization program 134, etc.

In step 204, dynamic workload optimization program 134 separates complex computer workloads, such as workload 132, into parts based on various factors, predetermined rules, etc. In this exemplary embodiment, dynamic workload optimization program 134 separates the applications of workload 132 into parts based on their identified respective, profiled characteristics (i.e., step 202). For example, if workload 132 comprises a webserver, a low latency app, a database, and an application server, all profiled by dynamic workload optimization program 134 to have different main characteristics (i.e., the low latency app is low latency, the database is I/O intensive, etc.), dynamic workload optimization program 134 would separate workload 132 into four separate, parts: the webserver part, the low latency app part, the database part, and the application server part. In various embodiments, workload 132 can include more or less applications. In various additional embodiments, some of the parts may have the same characteristics and be broken down accordingly. For example, if workload 132 had the four applications comprising a webserver, a low latency app, a database, and an application server, and the webserver and the application server were both profiled as memory intensive, the database was profiled as I/O intensive, and the low latency app was profiled as low latency, dynamic workload optimization program 134 would separate workload 132 into three parts: the low latency app part, the database part, and the webserver and the application server part.

In step 206, dynamic workload optimization program 134 migrates the parts to a suitable, tuned, featured zone in a cloud environment. In this exemplary embodiment, when workload 132 has been profiled and broken into four separate parts (e.g., step 202 and step 204 respectively), dynamic workload optimization program 134 migrates the respective parts into the tuned featured zone 122 portion of cloud environment 120 that dynamic workload optimization program determines is suitable for the characteristics of the respective parts. For example, dynamic workload optimization program 134 has separated workload 132 into four identified parts in step 204: the database that dynamic workload optimization program 134 determined to be an I/O intensive part, the webserver that dynamic workload optimization program 134 determined to be a very lightweight CPU usage part, the application server that dynamic workload optimization program 134 determined was a memory intensive part, and the low latency app that dynamic workload optimization program 134 determined to be a low latency part.

Dynamic workload optimization program 134 then migrates these individual parts into the featured zones of the cloud environment 120 that are tuned for these types of parts. For instance, the database part of workload 132 would be migrated to the featured zone that is tuned for I/O intensive applications, the webserver part of workload 132 would be migrated to the featured zone that is tuned for very lightweight CPU usage, etc.

In various embodiments, dynamic workload optimization program 134 dynamically profiles and migrates applications to tuned, featured zones based on such items as workload characteristics, changes in applications needs, changes in featured zones, etc. In various other embodiments, each of the featured zones are tuned following rules set up by the owner of the cloud environment 120, by the business or user migrating the parts or workload 132 to cloud environment 120, by the needs identified by dynamic workload optimization program 134, etc.

In various other embodiments, dynamic workload optimization program 134 dynamically recognizes the featured zones, and profiles and migrates parts based on the featured zones. In additional embodiments, the featured zones of cloud environment 120 can be tuned differently, added to, or removed from, depending on those using cloud environment 120, the owner of cloud environment 120, etc. In this example, the featured zones of cloud environment 120 can be tuned differently, added to, or removed from by the user, dynamic workload optimization program 134, etc. In further additional embodiments, dynamic workload optimization program 134 can dynamically recognize changes to the featured zones, profile, and migrate the parts of workload 132 accordingly.

FIG. 5A is a visualization depicting various featured zones in a cloud environment, in accordance with an embodiment of the present invention.

In this exemplary embodiment, cloud environment 120 is broken into four featured zones: lightweight CPU zone 330; low latency zone 340; I/O intensive zone 350; and memory intensive zone 360. Each of these featured zones are tuned with specific features to help create efficient processing of workload parts that are migrated to the zone. For example, low latency zone 340 has tunings such as low latency NIC 342, IRQ pinning 344, and adapter tunings 346, all of which are helpful for processing low latency applications. On the other hand, I/O intensive zone 350 has such tunings as access to solid state drive (SSD) disks 352 and I/O tunings 354, all of which are helpful for processing I/O intensive applications, and memory intensive zone 360 has such tunings as memory prefetch optimizations 362 and malloc libraries 364, all of which are helpful for processing memory intensive applications. Each of these featured zones is a segment of cloud environment 120, or a virtual machine running on cloud environment 120, tuned based on rules from the owner, user, etc. of cloud environment 120. In various embodiments, the tunings are changed, added to, or subtracted from, and the zones can change, have more zones added, or have zones removed.

FIG. 5B is a visualization that depicts a migration of parts of a workload to a cloud environment, in accordance with an embodiment of the present invention.

In this exemplary embodiment, dynamic workload optimization program 134 has profiled workload 132, broken workload 132 into parts, or individual applications, and migrated the parts to their respective tuned, featured zones in cloud environment 120. In this embodiment, dynamic workload optimization program 134 has received workload 132, has profiled workload 132 into four respective parts: webserver 312; low latency app 314; database 316; and application server 318. In this specific embodiment, dynamic workload optimization program 134 performs migration and tuning 320. Migration and tuning 320 is the process of separating workload 132 into separate, parts and migrating the parts via network 110 (not shown) to the zones that dynamic workload optimization program 134 has determined match the profiles of the various parts.

In this embodiment, dynamic workload optimization program 134 identifies and determines through profiling workload 132, and the various pieces therein, that webserver 312 is an application that may function well with a lightweight CPU, low latency app 314 is an application such as a stock market application that in order to deliver packets of information quickly may perform better with low latency, database 316 is an application such as a SQL database that may be I/O intensive, and application server 318 is an application such as a server built on java that may perform better with large chunks of network traffic for buffering and coalescing data, and so may be memory intensive. Because of this profiling, dynamic workload optimization program 134 has moved webserver 312 to be processed by lightweight CPU zone 330, low latency app 314 to be processed by low latency zone 340, database 316 to be processed by I/O intensive zone 350, and application server 318 to be processed by memory intensive zone 360.

In various embodiments, dynamic workload optimization program 134 profiles and migrates applications to featured zones based on such items as workload characteristics, changes in applications needs, changes in featured zones, etc. For example, dynamic workload optimization program 134 may continue to monitor workload 132 and the applications, etc. associated with workload 132, and cloud environment 120 and the featured zones therein. In this example, if it was determined by dynamic workload optimization program 134 that there was a change in the needs of the application, or a change in the tuning of the featured zones wherein applications may fit better into a different featured zone, dynamic workload optimization program 134 can migrate certain applications to a different featured zone than the one the application was currently in. For instance, if there are changes in webserver 312, due to changes in coding, a vast increase in usage, etc., that cause webserver 312 to be profiled as I/O intensive, dynamic workload optimization program 134 can move webserver 312 to a more appropriate featured zone.

In another embodiment, dynamic workload optimization program 134 determines that there is not a zone appropriate for webserver 312, and dynamically creates a new featured zone that is tuned to suit the characteristics of webserver 312 that dynamic workload optimization program 134 identified through profiling webserver 312. In some examples, dynamic workload optimization program 134 may retune an existing featured zone to suit the characteristics of webserver 312.

In various embodiments, the monitoring of workload 132 and the applications, etc. associated with workload 132 is done through performance profilers. The performance profilers may run in the background, monitor such items as the resource consumption for each application, and return the data to dynamic workload optimization program 134.

FIG. 6 is a block diagram of internal and external components of a computer system 400, which is representative of the computer systems of FIG. 3, in accordance with an embodiment of the present invention. It should be appreciated that FIG. 6 provides only an illustration of one implementation and does not imply any limitations with regard to the environments in which different embodiments may be implemented. In general, the components illustrated in FIG. 6 are representative of any electronic device capable of executing machine-readable program instructions. Examples of computer systems, environments, and/or configurations that may be represented by the components illustrated in FIG. 6 include, but are not limited to: personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In general, memory 406 can include any suitable volatile or non-volatile computer-readable storage media. Software (e.g., dynamic workload optimization program 134, etc.) is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 410 provides for communications with other computer systems or devices. In this exemplary embodiment, communications unit 410 includes network adapters or interfaces such as a TCP/IP adapter cards, wireless local area network (WLAN) interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded through communications unit 410 (e.g., via the Internet, a local area network or other wide area network). From communications unit 410, the software and data can be loaded onto persistent storage 408.

One or more I/O interfaces 412 allow for input and output of data with other devices that may be connected to computer system 400. For example, I/O interface 412 can provide a connection to one or more external devices 418 such as a keyboard, computer mouse, touch screen, virtual keyboard, touch pad, pointing device, or other human interface devices. External devices 418 can also include portable computer-readable storage media such as, for example, thumb drives, portable optical or magnetic disks, and memory cards. I/O interface 412 also connects to display 420.

Display 420 provides a mechanism to display data to a user and can be, for example, a computer monitor. Display 420 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to: an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, features associated with a workload;
separating, by one or more processors, the workload into a plurality of parts, based, at least in part, on the identified features;
determining, by one or more processors, a respective zone of a plurality of zones is suitable for at least one part of the plurality of parts in a cloud environment; and
responsive to determining the respective zone of the plurality of zones is suitable, migrating, by one or more processors, the one part to the respective zone determined to be suitable.

2. The method of claim 1, further comprising:
responsive to a change in the identified features, reevaluating, by one or more processors, whether the respective zone of the plurality of zones is still suitable for the one part.

3. The method of claim 2, further comprising:
responsive to the reevaluation that the respective zone of the plurality of zones is not suitable for the one part, determining, by one or more processors, a different respective zone of the plurality of zones is suitable for the one part, based, at least in part, on the change in the identified features; and
migrating, by one or more processors, the one part to the different respective zone.

4. The method of claim 2, further comprising:
responsive to the reevaluation that the respective zone of the plurality of zones is suitable for the one part, maintaining, by one or more processors, the one part in the respective zone of the plurality of zones.

5. The method of claim 1, further comprising:
continuously monitoring, by one or more processors, data inputs associated with the workload; and
updating, by one or more processors, the features associated with the workload, based on the data inputs.

6. The method of claim 1, further comprising:
responsive to determining the respective zone of the plurality of zones is not suitable for at least one part of the plurality of parts in the cloud environment, creating, by one or more processors, a new respective zone suitable for the one part; and
migrating, by one or more processors, the one part to the new respective zone.

7. The method of claim 1, further comprising:
responsive to determining the respective zone of the plurality of zones is not suitable for at least one part of the plurality of parts in the cloud environment, retuning, by one or more processors, the respective zone of the plurality of zones to be suitable for the one part; and
migrating, by one or more processors, the one part to the retuned respective zone.

8. A computer program product comprising:
one or more computer readable storage medium and program instructions stored on the computer readable storage medium, the program instructions comprising:
program instructions to identify features associated with a workload;
program instructions to separate the workload into a plurality of parts, based, at least in part, on the identified features;
program instructions to determine a respective zone of a plurality of zones is suitable for at least one part of the plurality of parts in a cloud environment; and
responsive to determining the respective zone of the plurality of zones is suitable, program instructions to migrate the one part to the respective zone determined to be suitable.

9. The computer program product of claim 8, further comprising:
responsive to a change in the identified features, program instructions to reevaluate whether the respective zone of the plurality of zones is still suitable for the one part.

10. The computer program product of claim 9, further comprising:
responsive to the reevaluation that the respective zone of the plurality of zones is not suitable for the one part, program instructions to determine a different respective zone of the plurality of zones is suitable for the one part, based, at least in part, on the change in the identified features; and
program instructions to migrate the one part to the different respective zone.

11. The computer program product of claim 9, further comprising:
responsive to the reevaluation that the respective zone of the plurality of zones is suitable for the one part, program instructions to maintain the one part in the respective zone of the plurality of zones.

12. The computer program product of claim 8, further comprising:
program instructions to continuously monitor data inputs associated with the workload; and
program instructions to update the features associated with the workload, based on the data inputs.

13. The computer program product of claim 8, further comprising:
responsive to determining the respective zone of the plurality of zones is not suitable for at least one part of the plurality of parts in the cloud environment, program instructions to create a new respective zone suitable for the one part; and
program instructions to migrate the one part to the new respective zone.

14. The computer program product of claim 8, further comprising:
responsive to determining the respective zone of the plurality of zones is not suitable for at least one part of the plurality of parts in the cloud environment, program instructions to retune the respective zone of the plurality of zones to be suitable for the one part; and
program instructions to migrate the one part to the retuned respective zone.

15. A computer system comprising:
one or more computer processors;
one or more computer readable storage media;
program instructions stored on the one or more computer readable storage media for execution by at least one or the one or more processors, the program instructions comprising:
program instructions to identify features associated with a workload;
program instructions to separate the workload into a plurality of parts, based, at least in part, on the identified features;
program instructions to determine a respective zone of a plurality of zones is suitable for at least one part of the plurality of parts in a cloud environment; and
responsive to determining the respective zone of the plurality of zones is suitable, program instructions to migrate the one part to the respective zone determined to be suitable.

16. The computer system of claim 15, further comprising:
responsive to a change in the identified features, program instructions to reevaluate whether the respective zone of the plurality of zones is still suitable for the one part.

17. The computer system of claim 16, further comprising:
responsive to the reevaluation that the respective zone of the plurality of zones is not suitable for the one part, program instructions to determine a different respective zone of the plurality of zones is suitable for the one part, based, at least in part, on the change in the identified features; and
program instructions to migrate the one part to the different respective zone.

18. The computer system of claim 16, further comprising:
responsive to the reevaluation that the respective zone of the plurality of zones is suitable for the one part, program instructions to maintain the one part in the respective zone of the plurality of zones.

19. The computer system of claim 15, further comprising:
responsive to determining the respective zone of the plurality of zones is not suitable for at least one part of the plurality of parts in the cloud environment, program instructions to create a new respective zone suitable for the one part; and
program instructions to migrate the one part to the new respective zone.

20. The computer system of claim 15, further comprising:
responsive to determining the respective zone of the plurality of zones is not suitable for at least one part of the plurality of parts in the cloud environment, program instructions to retune the respective zone of the plurality of zones to be suitable for the one part; and
program instructions to migrate the one part to the retuned respective zone.
